(19) United States
(12) Patent Application Publication
(10) Pub. No.: US 2016/0086532 A1
(43) Pub. Date: Mar. 24, 2016

(54) TIMING CONTROLLER, ORGANIC LIGHT EMITTING DISPLAY DEVICE HAVING THE SAME, AND METHOD OF DRIVING THE ORGANIC LIGHT EMITTING DISPLAY DEVICE

(71) Applicant: SAMSUNG DISPLAY CO., LTD., Yongin-City (KR)

(72) Inventors: Min-Ha KEUM, Yongin-si (KR); Woo-Chul KIM, Seoul (KR)

(21) Appl. No.: 14/627,073

(22) Filed: Feb. 20, 2015

(30) Foreign Application Priority Data
Sep. 18, 2014 (KR) 10-2014-0214162

(51) Int. Cl. G09G 3/32

(52) U.S. Cl. CPC G09G 3/3225; G09G 3/3275; G09G 3/3266; G09G 2320/0233; G09G 2310/08

(57) ABSTRACT

A timing controller for a display includes a receiver, a calculator, a storage device, and a generator. The receiver receives data and a data enable input signal. The calculator calculates a length of an input frame based on the data enable input signal. The storage device stores information indicative of the length of the input frame. The generator generates a data enable output signal having a predetermined number of pulses based on the stored length information. The pulses of the data enable output signal are distributed in a substantially uniform manner within an output frame, the data is output synchronized with the data enable output signal.

### CROSS-REFERENCE TO RELATED APPLICATION

Korean Patent Applications No. 10-2014-0124162, filed on Sep. 18, 2014, and entitled, “Timing Controller, Organic Light Emitting Display Device Having the Same, and Method of Driving the Organic Light Emitting Display Device,” is incorporated by reference herein in its entirety.

### BACKGROUND

1. Field

One or more embodiments described herein relate to a timing controller, an organic light emitting display device having a timing controller, and a method for driving an organic light emitting display device.

2. Description of the Related Art

An active matrix organic light emitting display may be driven by an analog driving method or a digital driving method. The analog driving method produces grayscale values based on a variable voltage data levels. The digital driving method produces grayscale values based on variable time durations for emitting light.

In a display driven by an analog driving method, it is difficult to manufacture the driving integrated circuit (IC) as panel size and resolution increases. However, in a display driven by a digital driving method, it is easier to manufacture the IC at high resolutions in some circumstances.

Also, in a display driven by a digital driving method, on and off states of the driving thin film transistors (TFTs) are seldom influenced by image quality deterioration due to a TFT characteristic deviation. Therefore, digital driving methods are have often been the choice for large panels.

A display driven by a digital driving method may use a timing controller to generate a data enable output signal based on a data enable input signal provided from an external system. However, when the data enable input signal has abnormal timing, the timing controller may output the data enable output signal with abnormal timing. Because the data enable output signal is used to generate control signals for the data driver and scan driver, a data enable output signal with abnormal timing may adversely affect image-quality, e.g., omission of an image or color abnormality may result.

### SUMMARY

In accordance with one embodiment, a timing controller includes a receiver to receive data and a data enable input signal; a calculator to calculate a length of an input frame based on the data enable input signal; a storage area to store information indicative of the length of the input frame; a generator to generate a data enable output signal having a predetermined number of pulses based on the stored length information, the predetermined number of pulses of the data enable output signal to be distributed in a substantially uniform manner within an output frame; and an output to output the data synchronized with the data enable output signal.

The generator may determine a width of each of the predetermined number of pulses based on a quotient of the length of the input frame and the number of the pulses of the data enable output signal. The input frame may include an active period and a blank period. The output frame may exclude the blank period. The calculator may calculate the length of the input frame based on a time of the active period and a time of the blank period. The calculator may include a clock generator to generate reference clock signals having a predetermined cycle, and the calculator may calculate the length of the input frame based on a number of counted reference clock signals generated by the clock generator during the active period and the blank period. The generator may receive the length of the input frame from the storage area for a predetermined time after the length of the input frame is stored in the storage area.

In accordance with another embodiment, an organic light emitting display device includes a display panel having a plurality of pixels; a scan driver to provide a scan signal to the pixels; a data driver to provide a data signal to the pixels; and a timing controller to control the scan driver and the data driver, wherein the timing controller is to receive a data enable input signal and is to generate a data enable output signal having a predetermined number of pulses based on a length of an input frame, the predetermined number of pulses of the data enable output signal to be distributed in a substantially uniform manner within an output frame.

The timing controller includes a receiver to receive data and the data enable input signal; a calculator to calculate the length of the input frame based on the data enable input signal; a storage area to store information indicative of the length of the input frame; a generator to generate the data enable output signal having the predetermined number of the pulses based on the stored length information; and an output to output the data synchronized with the data enable output signal.

The generator may determine a width of each of the pulses of the data enable output signal based on a quotient of the length of the input frame and the number of the pulses of the data enable output signal. The timing controller may include a control signal generator to generate a scan control signal to control the scan driver and a data control signal to control the data driver according to the data enable output signal. The input frame may include an active period and a blank period. The output frame may exclude the blank period.

The calculator may calculate the length of input frame based on a time of the active period and a time of the blank period. The calculator may include a clock generator to generate reference clock signals having a predetermined cycle, and the calculator may calculate the length of the input frame based on a number of counted reference clock signals generated by the clock generator during the active period and the blank period. The generator may receive the stored length information for a predetermined time after the length of the input frame is stored in the storage area.

In accordance with another embodiment, a method for driving an organic light emitting display device includes receiving data and a data enable input signal; calculating a length of an input frame based on the data enable input signal; generating a data enable output signal having a predetermined number of pulses based on the length of the input frame, the predetermined number of the pulses distributed in a substantially uniform manner within an output frame; and outputting the data synchronized with the data enable output signal.

A width of each of the pulses of the data enable output signal may be determined based on a quotient of the length of the input frame and the number of the pulses of the data enable output signal. The input frame may include an active period and a blank period, and the length of the input frame may be calculated based on a time of the active period and a time of the blank period. The input frame may include an active period and a blank period, and the length of the input frame may be calculated based on a counted number of reference clock signals having a predetermined cycle generated during the active period and the blank period.

### BRIEF DESCRIPTION OF THE DRAWINGS

Features will become apparent to those of skill in the art by describing in detail exemplary embodiments with reference to the attached drawings in which:

FIG. 1 illustrates an embodiment of a timing controller;

FIG. 2 illustrates an embodiment of a data enable input signal and a data enable output signal of the timing controller;

FIG. 3 illustrates an embodiment of input and output frames of the timing controller;

FIGS. 4A and 4B illustrate an operation performed by one embodiment of an input frame length calculating unit;

FIG. 5 illustrates an embodiment of an organic light emitting display device;

FIG. 6 illustrates an embodiment of an electronic device;

FIG. 7 illustrates an embodiment of a smart phone; and

FIG. 8 illustrates an embodiment of a method for driving a display.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

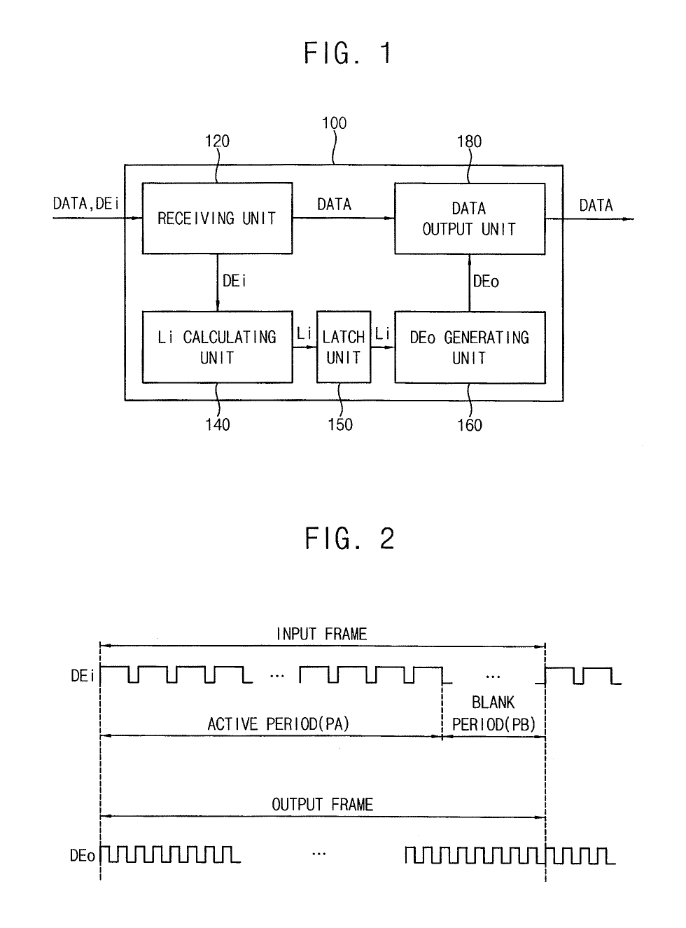

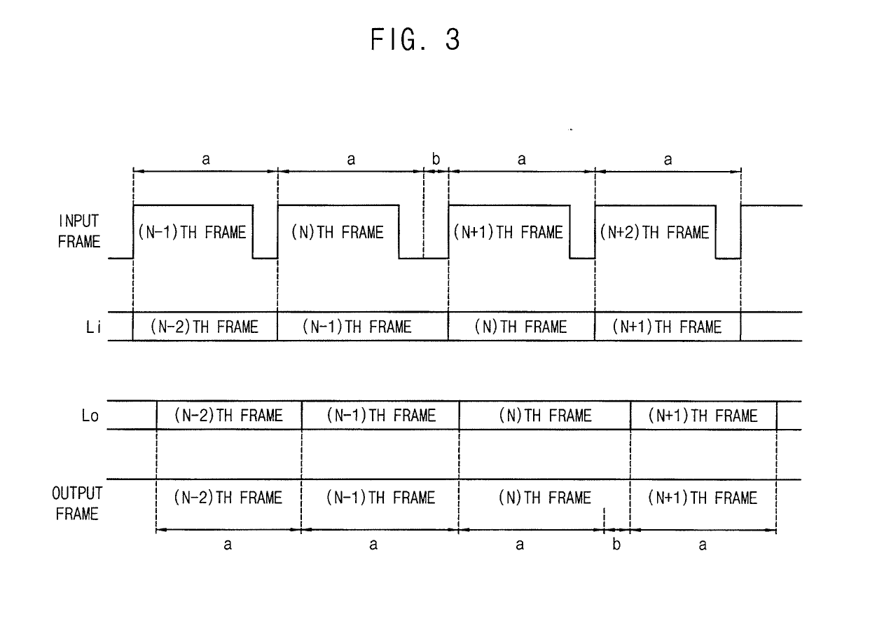

FIG. 1 illustrates an embodiment of a timing controller 100 of an organic light emitting display device driven by a digital driving method. FIG. 2 is waveform diagram illustrating a data enable input signal and a data enable output signal for describing an operation of the timing controller according to one embodiment. FIG. 3 is a waveform diagram illustrating an input frame and an output frame for describing an operation of the timing controller according to one embodiment.

Referring to FIG. 2, the timing controller 100 may generate a data enable output signal DEo based on a data enable input signal Dei from an external system. The data enable input signal DEi may be provided on a per input frame basis, and each of the input frames may include an active period PA and a blank period PB.

The data enable input signal DEi may output pulses that are uniformly distributed within the active period PA and may not output pulses within the blank period PB. The data enable output signal DEo may be generated per each output frame, which according to one embodiment does not include blank period PB. Moreover, the data enable output signal DEo may output pulses that are uniformly distributed within the output frame.

When the data enable input signal DEi is abnormally provided (e.g., as a result of one or more external factor such as but not limited to static electricity), the data enable output signal DEo may be abnormally generated. For example, the data enable input signal DEi may be earlier or later than desired because of static electricity.

Referring to FIG. 1, to overcome this problem, the timing controller 100 may calculate a length of the input frame Li, and then may change the length of the output frame Lo and/or the width of the pulse of the data enable output signal based on the length of the input frame Li. Through this adjustment, the timing controller 100 may stably generate the data enable output signal DEo, even though the length of the input frame Li is changed.

Referring to FIGS. 1 to 3, according to one embodiment the timing controller 100 includes a receiving unit 120, a input frame length calculating unit 140, a latch unit 150, a data enable output signal generating unit 160, and a data output unit 180.

The receiving unit (or receiver) 120 receives input data DATA and the data enable input signal DEi from an external system. The receiving unit 100 receives the input data from the external system through a specific interface-type per frame, and provides the input data to the data output unit 180. The input data DATA may include data for different colors, e.g., red input data, green input data, and blue input data.

Further, the receiving unit 100 receives the data enable input signal DEi. The data enable input signal DEi may be provided on a per frame basis. One input frame includes an active period PA and a blank period PB. The data enable input signal DEi may include pulses that are uniformly distributed in the active period PA of the input frame and may not include output pulses in the blank period PB of the input frame.

In case of a display device operating with a fixed driving frequency, lengths of the input frames Li may be the same. The length of the input frame Li may indicate a time during which the data enable signal DEi is input. When the data enable input signal DEi is normally provided, the lengths of each of the input frames Li may be the same.

However, when the data enable input signal DEi is provided earlier or later than desired, for example, because of an external factor (e.g. static electricity), the length of one or more of the input frames Li may change. For example, when the data enable input signal DEi of an (N+1)th frame is input late, the length of an (N)th input frame Li may be increased (a+b), as illustrated in FIG. 3. The receiving unit 120 may provide the data enable input signal DEi to the input frame length calculating unit 140.

The input frame length calculating unit (or calculator) 140 calculates the length of the input frame Li based on the data enable input signal DEi. The input frame length calculating unit 140 may calculate the length of the input frame Li by detecting a rising timing of the blank period PB, because one input frame includes the active period PA and the blank period PB as illustrated in FIG. 2.

In one embodiment, the input frame length calculating unit 140 may measure the time of the active period PA of the input frame and the time of the blank period PB of the input frame using a timer. The input frame length calculating unit 140 may calculate the length of the input frame Li by adding the time of the active period PA of the input frame and the time of the blank period PB of the input frame. For example, when the length of the (N)th input frame Li is increased (a+b) as illustrated in FIG. 3, the time of the blank period PB of the (N)th input frame may be measured longer than the time of other frames.

In another embodiment, the input frame length calculating unit 140 may include a clock generating unit that generates a reference clock having a predetermined cycle, and may calculate the length of the input frame Li by counting the reference clock during the active period PA of the input frame and the blank period PB of the input frame. The input frame length calculating unit 140 may calculate the length of the input frame Li, for example, by multiplying the cycle of the reference clock by the number of the counted reference clocks. For example, when the length of the (N)th input frame Li is increased (a+b) as illustrated in FIG. 3, the number of the counted reference clocks output during the blank period PB of the (N)th input frame may be greater than the number for other frames. The output of the input frame length calculating unit 140 is provided to the latch unit 150.

The latch unit (or store) 150 temporarily stores information indicative of the length of the input frame Li.

The data enable output signal generating unit (or generator) 160 receives the information indicative of the length of the input frame from the latch unit 150 for a predetermined time after the length information of the input frame is stored in the latch unit 150.

The data enable output signal generating unit 160 generates the data enable output signal DEo having a predetermined number of the pulses based on the length of the input frame Li, such that the pulses of the data enable output signal DEo are uniformly distributed in the output frame. The number of pulses of the data enable output signal DEo that will be output during one output frame may be predetermined.

For example, for an organic light emitting display device having 1920*1080 resolution, the timing controller 100 receives a vertical data enable input signal that includes 1080 pulses within one input frame. The timing controller 100 then generates a vertical data enable output signal with 10,800 pulses within one output frame.

The number of pulses of the data enable output signal DEo in one output frame may change according to the driving method of the organic light emitting display device. The data enable output signal generating unit 160 may determine the width of each pulse of the data enable output signal DEo by dividing the length of the input frame by the number of the pulses of the data enable output signal DEo. For example, when the length of the (N)th input frame Li is increased (a+b) as illustrated in FIG. 3, the width of each pulse of the data enable output signal DEo output during the (N)th frame may be greater than the width of each of the pulses in other frames.

The length of the output frame Lo that outputs the data enable output signal DEo may be determined by the length of the input frame Li, because the data enable output signal DEo is generated having a pulse width changed by the length of the input frame Li. In one embodiment, when the length of the (N)th input frame Li is increased (a+b) as illustrated in FIG. 3, the length of the (N)th output frame Lo may be determined as the same as the length of the (N)th input frame Li.

The data output unit 180 outputs the input data DATA in synchronization with the data enable output signal DEo. The data output unit 180 outputs the input data DATA, input from the external system, in synchronization with the data enable output signal DEo generated corresponding to the length of the input frame Li.

Thus, the timing controller 100 may stably generate the data enable output signal DEo having pulses that area uniformly distributed, even though the data enable input signal DEi is abnormal, by calculating the length of the input frame Li and then changing the length of the output frame Lo and the width of the pulses of the data enable output signal DEo according to the length of the input frame Li.

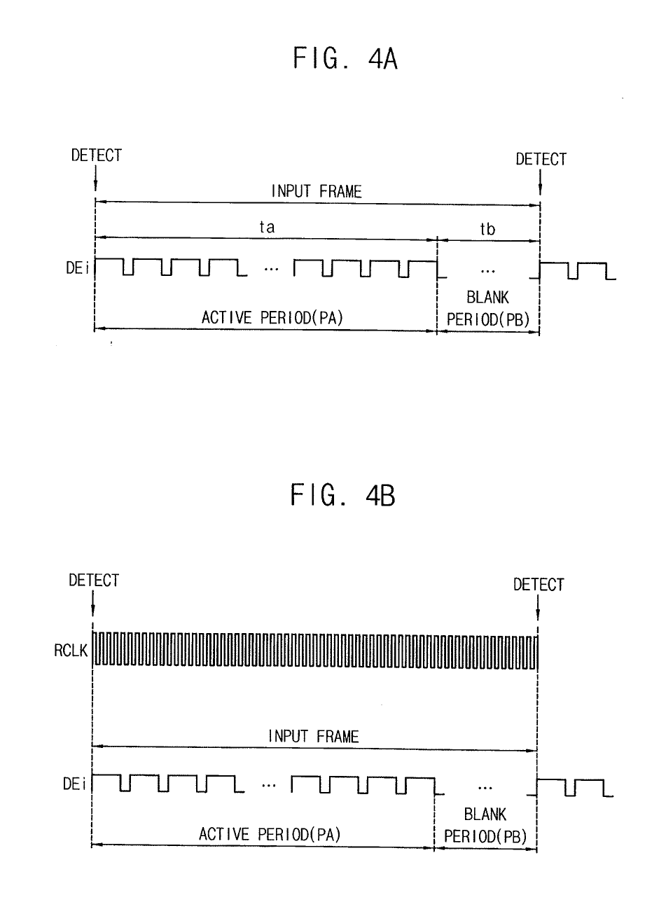

FIGS. 4A and 4B illustrates operation of an input frame length calculating unit according to one embodiment. The input frame length calculating unit may be unit 140 in the timing controller 100 of FIG. 1.

Referring to FIG. 4A, the input frame length calculating unit 140 measures the time of the active period PA of the input frame and the time of the blank period PB of the input frame, for example, using a timer. The length of the input frame indicates a time during which the data enable input signal DEi is input.

The input frame length calculating unit 140 may measure the active period PA of the input frame and the blank period PB of the input frame using the timer, and may calculate the length of the input frame Li by adding the time of the active period PA to the time of the blank period PB. For example, in the case where the organic light emitting display device operates at 60 Hz, one input frame may be output during 1/60 sec. However, when the length of the (N)th input frame Li is increased (a+b) as illustrated in FIG. 3, the length of the (N)th input frame Li may be measured to be longer than 1/60 sec.

Referring to FIG. 4B, the input frame length calculating unit 140 may include a clock generating unit, and may calculate the length of the input frame Li by counting the number of reference clock signals output during the active period PA of the input frame and the blank period PB of the input frame. The length of the input frame may indicate a time during which the data enable input signal DEi is input. The input frame length calculating unit 140 may calculate the length of the input frame Li by multiplying the cycle of the reference clock by the number of the reference clock. For example, when the organic light emitting display device operates at 60 Hz and the clock generating unit generates the reference clock per 1/600 sec, the clock generating unit may output 100 reference clock signals during one input frame. However, when the length of the (N)th input frame Li is increased (a+b) as illustrated in FIG. 3, the number of reference clock signals output during the blank period PB of the (N)th input frame may be counted to be more than 100.

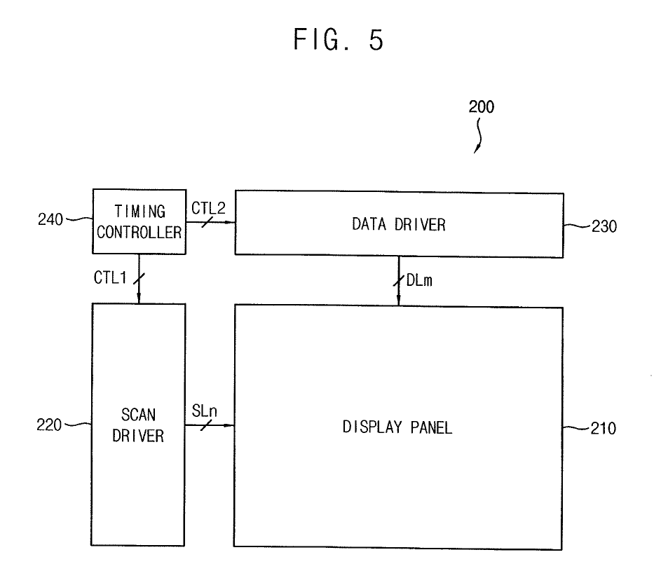

FIG. 5 illustrates an embodiment of an organic light emitting display device 200 which includes a display panel 210, a scan driver 220, a data driver 230, and a timing controller 240. The display panel 210 includes a plurality of pixels at intersection regions of data lines DLm and scan lines SLn. Each pixel may include an organic light emitting diode. In one embodiment, each pixel includes a pixel circuit having a driving transistor and an organic light emitting diode. In this case, the pixel circuit may operate to provide a data signal to the driving transistor based on a scan signal. The data signal may be provided via a corresponding one of the data lines DLm, and the scan signal is provided via a corresponding one of the scan-lines SLn. The driving transistor controls the amount of current flowing through the organic light emitting diode based on the data signal. The organic light emitting diode emits light based on the current.

The scan driver 220 provides a scan signal to the pixels via the scan lines SLn. The data driver 230 provides data signals to the pixels via the data lines DLm according to the scan signal.

The timing controller 240 receives a data enable input signal, and generates a data enable output signal having a predetermined number of the pulses based on the length of an input frame, so that pulses of the data enable output signal are uniformly distributed within an output frame. For example, the timing controller 240 may include a receiving unit, an input frame length calculating unit, a latch unit, a data enable output signal generating unit, and a data output unit. These units may be the same or different from the units illustrated in FIG. 1.

For example, the receiving unit may receive an input data and the data enable input signal from an external system. The receiving unit may receive the input data from the external system through a specific interface-type on a per-frame basis, and may provide the data to the data output unit. Further, the receiving unit may receive the data enable input signal and provide the data enable input signal to the input frame length calculating unit.

The input frame length calculating unit may calculate the length of the input frame based on the data enable input signal. The length of the input frame may indicate a time during which the data enable signal is input. The input frame length calculating unit may calculate the length of the input frame by detecting the rising timing of the blank period, where one input frame includes an active period and a blank period.

In one embodiment, the input frame length calculating unit measures a time of the active period of the input frame and a time of the blank period of the input frame using a timer. The input frame length calculating unit may calculate the length of the input frame by adding the time of the active period of the input frame and a time of the blank period of the input frame.

In another embodiment, the input frame length calculating unit may include a clock generating unit that generates a reference clock having a predetermined cycle. The input frame length calculating unit may calculate the length of the input frame by counting the number of reference clock signals during the active period of the input frame and the blank period of the input frame. The input frame length calculating unit may calculate the length of the input frame by multiplying the cycle of the reference clock by the number of reference clock signals. The latch unit temporarily stores information indicative of the length of the input frame.

The data enable output signal generating unit may receive the length information of the input frame from the latch unit for a predetermined time after the length of the input frame is stored in the latch unit. The data enable output signal generating unit may generate the data enable output signal having a predetermined number of pulses based on the length of the input frame, so that the pulses of the data enable output signal are uniformly distributed within the output frame. The data enable output signal generating unit may determine the width of each pulse of the data enable output signal by dividing the length of the input frame by the number of the pulses of the data enable output signal. The data output unit may output the input data in synchronization with the data enable output signal.

As previously described, the timing controller 240 of the organic light emitting display device 200 may stably generate the data enable output signal having pulses that are uniformly distributed, even though the data enable input signal is abnormally input, by calculating the length of the input frame and then changing the length of the output frame and the width of the pulses of the data enable output signal according to the length of the input frame.

The timing controller 240 may further include a control signal generating unit which generates a scan control signal CTL1 that controls the scan driver 220 according to the data enable output signal and a data control signal CTL2 that controls the data driver 230.

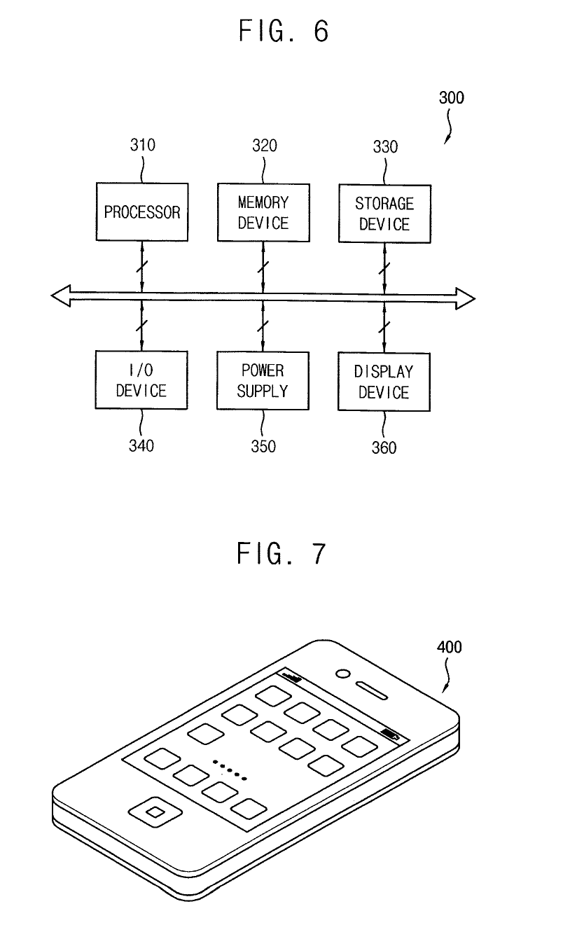

FIG. 6 illustrates an embodiment of an electronic device 300, which, for example, may include an of the aforementioned embodiments of the organic light emitting display. FIG. 7 illustrates an example of a smart phone 400 which corresponds to the electronic device 300.

Referring to FIGS. 6 and 7, electronic device 300 (and smart phone 400) includes a processor 310, a memory device 320, a storage device 330, an input/output (I/O) device 340, a power supply 350, and a display device 360. The display device 360 may correspond, for example, to the display device 200 of FIG. 5. In addition, the electronic device 300 may include a plurality of ports for communicating with a video card, a sound card, a memory card, a universal serial bus (USB) device, and/or another electronic device. Although FIG. 7 illustrates the electronic device 300 to be a smart phone 400, electronic device 300 may be a different type of electronic device in another embodiment.

The processor 310 may be, for example, a micro processor, a central processing unit (CPU), or another type of processing or computing device, for performing various computing functions The processor 310 may be coupled to other components, for example, via an address bus, a control bus, a data bus, and/or other signal lines. The processor 310 may also be coupled to an extended bus, such as but not limited to a peripheral component interconnect (PCI) bus.

The memory device 320 stores data relating to operations of the electronic device 300. For example, the memory device 320 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, or a ferroelectric random access memory (FRAM) device, and/or at least one volatile memory device such as a dynamic random access memory (DRAM) device, a static random access memory (SRAM) device, or a mobile DRAM device. The storage device 330 may be a solid state drive (SSD) device, a hard disk drive (HDD) device, or a CD-ROM device.

The I/O device 340 may be an input device such as a keyboard, a keypad, a touchpad, a touch-screen, or a mouse, and/or an output device such as a printer or a speaker. In one embodiment, the display device 360 may be included in the I/O device 340. The power supply 350 may provide power for operations of the electronic device 300. The display device 360 may communicate with other components, for example, via the buses or other communication links.

The display device 360 may include a display panel, a scan driver, a data driver, and a timing controller as previously described. The display panel includes a plurality of pixels which emit light based on supplied current. The scan driver provides a scan signal to the pixels, and the data driver provide data signals according to the scan signal. The timing controller receives a data enable input signal and generates a data enable output signal based on the length of input frame of the data enable input signal, with a predetermined number of pulses in the data enable output signal.

For example, the timing controller includes a receiving unit, an input frame length calculating unit, a latch unit, a data enable output signal generating unit, and a data output unit, which, for example, may be the same or different from these units in FIG. 1. The receiving unit receives an input data and the data enable input signal from an external system.

The input frame length calculating unit calculates the length of the input frame based on the data enable input signal. The length of the input frame may indicate a time during which the data enable signal is input. In one embodiment, the input frame length calculating unit measures a time of an active period of the input frame and a time of a blank period of the input frame using a timer. In another embodiment, the input frame length calculating unit may include a clock generating unit that generates a reference clock having a predetermined cycle, and may calculate the length of the input frame by counting the number of reference clock signals during the active period of the input frame and the blank period of the input frame. The latch unit temporarily stores information indicative of the length of the input frame.

The data enable output signal generating unit receives the length information of the input frame from the latch unit for a predetermined time after the length of the input frame is stored in the latch unit. The data enable output signal generating unit generates the data enable output signal having a predetermined number of the pulses based on the length of the input frame, such that the pulses of the data enable output signal are uniformly distributed within the output frame. The data enable output signal generating unit may determine the width of each pulse of the data enable output signal by dividing the length of the input frame by the number of the pulses of the data enable output signal. The data output unit outputs the input data in synchronization with the data enable output signal.

The timing controller may further include a control signal generating unit. The control signal generating unit may generate a scan control signal that controls the scan driver according to the data enable output signal and a data control signal that controls the data driver. As previously described, the timing controller of the display device 360 may stably generate the data enable output signal having pulses that are uniformly distributed, even though the data enable input signal is abnormally input, by calculating the length of the input frame and then changing the length of the output frame and the width of the pulses of the data enable output signal according to the length of the input frame.

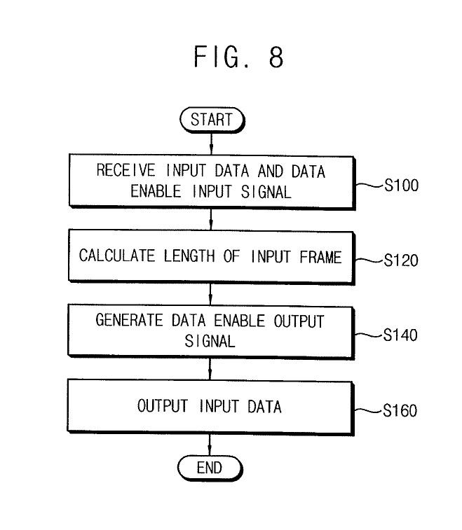

FIG. 8 illustrating an embodiment of a method for driving an organic light emitting display device, which, for example, may correspond to any of the aforementioned embodiments of the display device.

Referring to FIG. 8, the method includes receiving input data and a data enable input signal S100, and calculating the length of an input frame based on the data enable input signal S120. The method includes generating a data enable output signal having a predetermined number of the pulses based on the length of the input frame, such that the pulses of the data enable output signal are uniformly distributed within an output frame (S160). The method includes outputting the input data in synchronization with the data enable output signal.

The receiving operation in S100 may include receiving the input data and the data enable input signal from an external system. The data enable input signal may be input on a per-input frame basis. Each of the input frames may include an active period and a blank period. The data enable input signal may output pulses that are uniformly distributed within the active period and may not output pulses within the blank period. When the data enable input signal is normally input, each of the lengths of the input frame may be the same. The length of the input frame indicates a time during which the data enable signal is input. However, when the data enable input signal is input too soon or too late, because of one or more external factors (e.g. static electricity), the length of the input frame Li may be changed.

In the method of FIG. 8, the length of the input frame may be calculated based on the data enable input signal S120. The length of the input frame may be calculated by detecting a rising timing of the blank period because one input frame includes the active period and the blank period. In one embodiment, the length of the input frame may be calculated by measuring time of the active period of the input frame and a time of the blank period of the input frame. The length of the input frame may be calculated by adding the time of the active period of the input frame and the time of the blank period of the input frame.

In another embodiment, the length of the input frame may be calculated by counting the number of reference clock signals having a predetermined cycle during the active period of the input frame and the blank period of the input frame. The length of the input frame may be calculated by multiplying the cycle of the reference clock by the number of the reference clock signals. The length of the input frame may be temporarily stored in the latch unit. The length of the input frame from the latch unit may be provided to a data enable output signal generating unit for a predetermined time after the length of the input frame is stored in the latch unit.

In the method of FIG. 8, the data enable output signal may be generated to have a predetermined number of the pulses based on the length of the input frame, such that the pulses of the data enable output signal are uniformly distributed within the output frame S160. The number of the pulses of the data enable output signal that will be output during one output frame may be predetermined. The width of each pulse of the data enable output signal may be determined by dividing the length of the input frame by the number of the pulse of the data enable output signal.

In the method of FIG. 8, the input data may be output in synchronization with the data enable output signal S180. The input data from the external system may be output in synchronization with the data enable output signal that is generated corresponding to the length of the input frame.

As previously described, one or more embodiments of the method of driving the organic light emitting display device may receive the input data and the data enable input signal and may calculate the length of the input frame during which the data enable input signal is input. These embodiments may generate the data enable output signal having the width of pulse corresponding to the length of the input frame and may output the input data in synchronization with the data enable output signal.

Also, as previously described, one or more embodiments of the method for driving the organic light emitting display device stably generate the data enable output signal having pulses that are uniformly distributed, even though the data enable input signal is abnormally input, by calculating the length of the input frame and then changing the length of the output frame and the width of the pulses the data enable output signal according to the length of the input frame.

The aforementioned embodiments may be applied to a display device having a display panel. For example, the aforementioned embodiments may be applied to a computer monitor, a laptop, a digital camera, a cellular phone, a smart phone, a smart pad, a television, a personal digital assistant (PDA), a portable multimedia player (PMP), a MP3 player, a navigation system, a game console, or a video phone.

The methods, processes, and/or operations described herein may be performed by code or instructions to be executed by a computer, processor, controller, calculator, generator, or other signal processing device. The computer, processor, controller, calculator, generator, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

By way of summation and review, a timing controller of an organic light emitting display device driven by a digital driving method generates a data enable output signal based on a data enable input signal from an external system. However, when the data enable input signal having abnormal timing is provided, the timing controller may output the data enable output signal having abnormal timing. Since the timing controller generates control signals for a data driver and a scan driver based on the data enable output signal having abnormal timing, an image-quality defect may occur such as an omission of an image and a color abnormality.

In accordance with one or more of the aforementioned embodiments, a timing controller stably generates a data enable output signal having pulses that are uniformly distributed, even though the data enable input signal is abnormally input. This is accomplished by calculating the length of the input frame, and then changing the length of the output frame and the width of the pulses of the data enable output signal according to the length of the input frame.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A timing controller, comprising:
a receiver to receive data and a data enable input signal;
a calculator to calculate a length of an input frame based on the data enable input signal;
a storage area to store information indicative of the length of the input frame;
a generator to generate a data enable output signal having a predetermined number of pulses based on the stored length information, the predetermined number of pulses of the data enable output signal to be distributed in a substantially uniform manner within an output frame; and
an output to output the data synchronized with the data enable output signal.

2. The timing controller as claimed in claim 1, wherein the generator is to determine a width of each of the predetermined number of pulses based on a quotient of the length of the input frame and the number of the pulses of the data enable output signal.

3. The timing controller as claimed in claim 1, wherein the input frame includes an active period and a blank period.

4. The timing controller as claimed in claim 3, wherein the output frame excludes the blank period.

5. The timing controller as claimed in claim 3, wherein the calculator is to calculate the length of the input frame based on a time of the active period and a time of the blank period.

6. The timing controller as claimed in claim 3, wherein:
the calculator includes a clock generator to generate reference clock signals having a predetermined cycle, and
the calculator is to calculate the length of the input frame based on a number of counted reference clock signals generated by the clock generator during the active period and the blank period.

7. The timing controller as claimed in claim 1, wherein the generator is to receive the length of the input frame from the storage area for a predetermined time after the length of the input frame is stored in the storage area.

8. An organic light emitting display device, comprising:
a display panel having a plurality of pixels;
a scan driver to provide a scan signal to the pixels;
a data driver to provide a data signal to the pixels; and
a timing controller to control the scan driver and the data driver,
wherein the timing controller is to receive a data enable input signal and is to generate a data enable output signal having a predetermined number of pulses based on a length of an input frame, the predetermined number of pulses of the data enable output signal to be distributed in a substantially uniform manner within an output frame.

9. The device as claimed in claim 8, wherein the timing controller includes:
a receiver to receive data and the data enable input signal;
a calculator to calculate the length of the input frame based on the data enable input signal;
a storage area to store information indicative of the length of the input frame;
a generator to generate the data enable output signal having the predetermined number of the pulses based on the stored length information; and
an output to output the data synchronized with the data enable output signal.

10. The device as claimed in claim 9, wherein the generator is to determine a width of each of the pulses of the data enable output signal based on a quotient of the length of the input frame and the number of the pulses of the data enable output signal.

11. The device as claimed in claim 9, wherein the timing controller further includes:
a control signal generator to generate a scan control signal to control the scan driver and a data control signal to control the data driver according to the data enable output signal.

12. The device as claimed in claim 9, wherein the input frame includes an active period and a blank period.

13. The device as claimed in claim 12, wherein the output frame excludes the blank period.

14. The device as claimed in claim 12, wherein the calculator is to calculate the length of input frame based on a time of the active period and a time of the blank period.

15. The device as claimed in claim 12, wherein:
the calculator includes a clock generator to generate reference clock signals having a predetermined cycle, and
the calculator is to calculate the length of the input frame based on a number of counted reference clock signals generated by the clock generator during the active period and the blank period.

16. The device as claimed in claim 9, wherein the generator is to receive the stored length information for a predetermined time after the length of the input frame is stored in the storage area.

17. A method for driving an organic light emitting display device, the method comprising;
receiving data and a data enable input signal;
calculating a length of an input frame based on the data enable input signal;
generating a data enable output signal having a predetermined number of pulses based on the length of the input frame, the predetermined number of the pulses distributed in a substantially uniform manner within an output frame; and
outputting the data synchronized with the data enable output signal.

18. The method as claimed in claim 17, wherein a width of each of the pulses of the data enable output signal is determined based on a quotient of the length of the input frame and the number of the pulses of the data enable output signal.

19. The method as claimed in claim 17, wherein:
the input frame includes an active period and a blank period, and
the length of the input frame is calculated based on a time of the active period and a time of the blank period.

20. The method as claimed in claim 17, wherein:
the input frame includes an active period and a blank period, and
the length of the input frame is calculated based on a counted number of reference clock signals having a predetermined cycle generated during the active period and the blank period.
